(19) United States
(12) Patent Application Publication
(10) Pub. No.: US 2024/0187965 A1
(43) Pub. Date: Jun. 6, 2024

(54) METHOD FOR LOSSLESS UPSTREAM PACKET PROCESSING DURING MOVEMENT BETWEEN DONORS IN BACKHAUL AND ACCESS HOLE COMBINATION SYSTEM, AND METHOD FOR PROCESSING IP ADDRESS DURING SEPARATION OF CP AND UP

(71) Applicant: Samsung Electronics Co., Ltd., Suwon-si, Gyeonggi-do (KR)

(72) Inventor: June HWANG, Suwon-si (KR)

(21) Appl. No.: 18/553,130

(22) PCT Filed: Mar. 25, 2022
(86) PCT No.: PCT/KR2022/004190

§ 371 Date: Sep. 28, 2023

(30) Foreign Application Priority Data
Mar. 31, 2021 (KR) 10-2021-0042072

(51) Int. Cl. H04W 40/24; H04W 76/20; H04W 88/08; H04W 92/24

(52) U.S. Cl. CPC H04W 40/248; H04W 76/20; H04W 88/08; H04W 92/24

(57) ABSTRACT

The present disclosure relates to: a communication technique for merging IoT technology with a 5G communication system for supporting a data transmission rate higher than that of a 4G system; and a system therefor. The present disclosure can be applied to intelligent services (for example, smart homes, smart buildings, smart cities, smartcars or connected cars, healthcare, digital education, small businesses, security- and safety-related services, and the like) on the basis of 5G communication technology and IoT-related technology. In the present invention, a method and a device related to packet and IP address processing according to mobility in a backhaul and access hole combination system are disclosed.

### TECHNICAL FIELD

The disclosure relates to a wireless communication system, and more particularly, to a mobility processing method for a backhaul access hole coupling system.

### BACKGROUND ART

In order to satisfy increases in demand for wireless data traffic now that a 4G communication system is commercially available, efforts are being made to develop an enhanced 5G communication system or a pre-5G communication system. Therefore, a 5G communication system or a pre-5G communication system is referred to as a beyond 4G network communication system or a post long term evolution (LTE) system. In order to achieve a high data transmission rate, consideration is being given to implementing the 5G communication system in a mmWave band (e.g., 60 GHz band). In order to mitigate any route loss of electronic waves in a mmWave band and to increase transmission distances of electronic waves, the technologies of beamforming, massive multiple input and multiple output (MIMO), full dimensional MIMO (FD-MIMO), array antenna, analog beamforming, and large scale antenna are being discussed for the 5G communication system. Further, in order to enhance networks in the 5G communication system, the technologies of an innovative small cell, advanced small cell, cloud radio access network (cloud RAN), ultra-dense network, device to device communication (D2D), wireless backhaul, moving network, cooperative communication, coordinated multi-points (COMP), and interference cancellation are being developed. Further, hybrid frequency shift keying and quadrature amplitude modulation (FQAM) and sliding window superposition coding (SWSC), which are advanced coding modulation (ACM) schemes; and filter bank multi carrier (FBMC), non-orthogonal multiple access (NOMA), and sparse code multiple access (SCMA), which are advanced access technologies, are being developed for the 5G system.

Innovation of Internet from a human-centered connection network in which a human generates and consumes information to an Internet of Things (IOT) network that gives and receives and processes information to and from distributed constituent elements such as things has occurred. Internet of everything (IoE) technology in which big data processing technology through connection to a cloud server is combined with IoT technology has been appeared. In order to implement the IoT, technology elements such as sensing technology, wired and wireless communication and network infrastructure, service interface technology, and security technology are required; thus, nowadays, research is being carried out on technology of a sensor network, machine to machine (M2M), and machine type communication (MTC) for connection between things. In an IoT environment, an intelligent Internet technology (IT) service that collects and analyzes data generated in connected things to provide a new value to human lives may be provided. The IoT may be applied to the field of a smart home, smart building, smart city, smart car or connected car, smart grid, health care, smart home appliances, and high-tech medical service through fusion and complex connections between existing information technology (IT) and various industries.

Accordingly, various attempts for applying a 5G communication system to an IoT network are being made. For example, technologies such as a sensor network, machine to machine (M2M), and machine type communication (MTC) have been implemented by the technique of beamforming, MIMO, and array antenna, which are 5G communication technologies. Application of a cloud RAN as the foregoing big data processing technology may be an example of convergence of 5G technology and IoT technology.

As various services may be provided according to the above description and the development of a wireless communication system, a method for effectively providing these services is required.

### DISCLOSURE OF INVENTION

### Technical Problem

The disclosure relates to a method of preventing a loss of an uplink packet and a signal for internet protocol (IP) address allocation of an integrated access backhauled node (IAB node) when separating a control domain and a user domain in the case that the IAB node performs mobility between donor distributed units (DUs).

The disclosure provides a device and method capable of effectively providing a service in a mobile communication system.

### Solution to Problem

According to an embodiment of the disclosure to solve the above problems, a method of operating an integrated access and backhaul (IAB) node in a communication system may include receiving, from a source IAB node, a first radio resource control (RRC) message including a handover command and configuration information on a backhaul adaptation protocol (BAP) header; reconfiguring headers of acquired BAP packets based on configuration information on the header; and transmitting, to a target IAB node, a second RRC message for handover completion based on the handover command, wherein the configuration information on the BAP header may include information on mapping between an old routing identifier (ID) configured by a source donor and a new routing ID applied by a target donor.

Further, according to an embodiment of the disclosure, a method of operating a source integrated access and backhaul (IAB) node in a communication system may include acquiring, from a source donor, configuration information on a backhaul adaptation protocol (BAP) header; and transmitting, to an IAB node, a radio resource control (RRC) message including a handover command and configuration information on the BAP header, wherein the configuration information on the BAP header may include information on mapping between an old routing identifier (ID) configured by the source donor and a new routing ID applied by a target donor.

Further, according to an embodiment of the disclosure, a method of operating a target integrated access and backhaul (IAB) node in a communication system may include receiving, from an IAB node, a radio resource control (RRC) message for completion of handover from a source IAB node to the target IAB node; transmitting, to the IAB node, information on a backhaul adaptation protocol (BAP) mapping configuration through an F1 application protocol (F1AP); and receiving, from the IAB node, a BAP packet based on information on the BAP mapping configuration, wherein the handover command may be transmitted from the source IAB node to the IAB node together with configuration information on a BAP header, and the configuration information on the BAP header may include information on mapping between an old routing identifier (ID) configured by a source donor and a new routing ID applied by a target donor.

Further, according to an embodiment of the disclosure, an integrated access and backhaul (IAB) node in a communication system may include a communication unit; and a controller configured to control the communication unit to receive a first radio resource control (RRC) message including a handover command and configuration information on a backhaul adaptation protocol (BAP) header from a source IAB node, to reconfigure headers of the acquired BAP packets based on configuration information on the header, and to control the communication unit to transmit a second RRC message for handover completion to a target IAB node based on the handover command, wherein the configuration information on the BAP header may include information on mapping between an old routing identifier (ID) configured by a source donor and a new routing ID applied by a target donor.

Further, according to an embodiment of the disclosure, a source integrated access and backhaul (IAB) node in a communication system may include a communication unit; and a controller configured to acquire configuration information on a backhaul adaptation protocol (BAP) header from a source donor, and to control the communication unit to transmit a radio resource control (RRC) message including a handover command and configuration information on the BAP header to an IAB node, wherein the configuration information on the BAP header may include information on mapping between an old routing identifier (ID) configured by the source donor and a new routing ID applied by a target donor.

Further, according to an embodiment of the disclosure, a target integrated access and backhaul (IAB) node in a communication system may include a communication unit; and a controller configured to control the communication unit to receive, from an IAB node, a radio resource control (RRC) message for completion of handover from a source IAB node to the target IAB node, to control the communication unit to transmit information on a backhaul adaptation protocol (BAP) mapping configuration to the IAB node through an F1 application protocol (F1AP), and to control the communication unit to receive a BAP packet from the IAB node based on information on the BAP mapping configuration, wherein the handover command may be transmitted from the source IAB node to the IAB node together with configuration information on a BAP header, and the configuration information on the BAP header may include information on mapping between an old routing identifier (ID) configured by a source donor and a new routing ID applied by a target donor.

### Advantageous Effects of Invention

According to a disclosed embodiment of the disclosure, a UL backhaul adaptation protocol (BAP) packet that may be lost during inter donor DU migration of an IAB node can be transmitted to a target path without loss. Further, an IP address can be transmitted during dual connection.

### BRIEF DESCRIPTION OF DRAWINGS

FIG. 1 is a diagram illustrating a structure of an LTE system according to an embodiment of the disclosure.

FIG. 2 is a block diagram illustrating a radio protocol structure of an LTE system according to an embodiment of the disclosure.

FIG. 3 is a diagram illustrating a structure of a next generation mobile communication system according to an embodiment of the disclosure.

FIG. 4 is a block diagram illustrating a radio protocol structure of a next generation mobile communication system according to an embodiment of the disclosure.

FIG. 5 is a block diagram illustrating an internal structure of a terminal according to an embodiment of the disclosure.

FIG. 6 is a block diagram illustrating a constitution of a base station according to an embodiment of the disclosure.

FIG. 7 is a diagram illustrating topology information according to an embodiment of the disclosure.

FIG. 8A is a message flow diagram illustrating an operation in which a default UL configuration is included in a HO command message and transmitted and in which a BAP mapping configuration is transmitted to an F1AP after HO complete according to an embodiment of the disclosure.

FIG. 8B is a message flow diagram illustrating an operation in which a default UL configuration is included in a HO command message and transmitted and in which a BAP mapping configuration is transmitted to an F1AP after HO complete according to an embodiment of the disclosure.

FIG. 9A is a message flow diagram illustrating an operation in which a default UL configuration, a BAP mapping configuration, and a routing configuration are all transmitted through a HO command message according to an embodiment of the disclosure.

FIG. 9B is a message flow diagram illustrating an operation in which a default UL configuration, a BAP mapping configuration, and a routing configuration are all transmitted through a HO command message according to an embodiment of the disclosure.

FIG. 10A is a message flow diagram illustrating an operation in which BAP header change configuration information is included in a HO command and transmitted and in which a BAP mapping config is provided as an F1AP signal according to an embodiment of the disclosure.

FIG. 10B is a message flow diagram illustrating an operation in which BAP header change configuration information is included in a HO command and transmitted and in which a BAP mapping config is provided as an F1AP signal according to an embodiment of the disclosure.

FIG. 11 is a message flow diagram illustrating an operation of transmitting a header change configuration and a BAP mapping configuration together with a HO command according to an embodiment of the disclosure.

FIG. 12 is a diagram illustrating a scenario of processing an IP address in the case that a control plane and a user plane are separated in an IAB according to an embodiment of the disclosure.

### MODE FOR THE INVENTION

Advantages and features of the disclosure, and a method of achieving them will become apparent with reference to the embodiments described below in detail in conjunction with the accompanying drawings. However, the disclosure is not limited to the embodiments disclosed below, but may be implemented in various different forms, and only embodiments of the disclosure enable the disclosure to be complete, and are provided to fully inform the scope of the disclosure to those of ordinary skill in the art to which the disclosure belongs, and the disclosure is only defined by the scope of the claims. Like reference numerals refer to like components throughout the specification.

In this case, it will be understood that each block of message flow diagrams and combinations of the message flow diagrams may be performed by computer program instructions. Because these computer program instructions may be mounted in a processor of a general purpose computer, special purpose computer, or other programmable data processing equipment, the instructions performed by a processor of a computer or other programmable data processing equipment generate a means that performs functions described in the message flow diagram block(s). Because these computer program instructions may be stored in a computer usable or computer readable memory that may direct a computer or other programmable data processing equipment in order to implement a function in a particular manner, the instructions stored in the computer usable or computer readable memory may produce a production article containing instruction means for performing the function described in the message flow diagram block(s). Because the computer program instructions may be mounted on a computer or other programmable data processing equipment, a series of operation steps are performed on the computer or other programmable data processing equipment to generate a computer-executed process; thus, instructions for performing the computer or other programmable data processing equipment may provide steps for performing functions described in the message flow diagram block(s).

Further, each block may represent a portion of a module, a segment, or a code including one or more executable instructions for executing a specified logical function(s). Further, it should be noted that in some alternative implementations, functions recited in the blocks may occur out of order. For example, two blocks illustrated one after another may in fact be performed substantially simultaneously, or the blocks may be sometimes performed in the reverse order according to the corresponding function.

In this case, the term ‘-unit’ used in this embodiment means software or hardware components such as a field programmable gate array (FPGA) or an application specific integrated circuit (ASIC), and ‘-unit’ performs certain roles. However, ‘-unit’ is not limited to software or hardware. ‘-unit’ may be formed to reside in an addressable storage medium or may be formed to reproduce one or more processors. Therefore, as an example, ‘-unit’ includes components such as software components, object-oriented software components, class components, and task components, processes, functions, properties, procedures, subroutines, segments of program code, drivers, firmware, microcode, circuit, data, databases, data structures, tables, arrays, and variables. Functions provided in the components and ‘-units’ may be combined into a smaller number of components and ‘-units’ or may be further separated into additional components and ‘-units’. Further, components and ‘-units’ may be implemented to reproduce one or more CPUs in a device or secure multimedia card. Further, in an embodiment, ‘-unit’ may include one or more processors.

In the following description, in describing the disclosure, in the case that it is determined that a detailed description of a related well-known function or constitution may unnecessarily obscure the gist of the disclosure, a detailed description thereof will be omitted. Hereinafter, an embodiment of the disclosure will be described with reference to the accompanying drawings.

Hereinafter, a term identifying an access node used in the description, a term indicating network entities, a term indicating messages, a term indicating an interface between network objects, a term indicating various types of identification information and the like are exemplified for convenience of description. Accordingly, the disclosure is not limited to the terms described below, and other terms indicating an object having an equivalent technical meaning may be used.

Hereinafter, for convenience of description, the disclosure uses terms and names defined in the 3rd generation partnership project long term evolution (3GPP LTE) standard. However, the disclosure is not limited by the above terms and names, and may be equally applied to systems conforming to other standards. In the disclosure, an evolved node B (eNB) may be used interchangeably with a gNB for convenience of description. That is, a base station described as an eNB may represent a gNB. Further, the term ‘terminal’ may represent other wireless communication devices as well as mobile phones, NB-IOT devices, and sensors.

Hereinafter, a base station is a subject performing resource allocation of a terminal, and may be at least one of a gNode B, an eNode B, a node B, a base station (BS), a radio access unit, a base station controller, or a node on a network. The terminal may include a user equipment (UE), a mobile station (MS), a cellular phone, a smart phone, a computer, or a multimedia system capable of performing a communication function. The disclosure is not limited to the above example.

In particular, the disclosure may be applied to 3GPP NR (5th generation mobile communication standard). Further, the disclosure may be applied to intelligent services (e.g., smart home, smart building, smart city, smart car or connected car, healthcare, digital education, retail business, security and safety-related services and the like) based on 5G communication technology and IoT-related technology. In the disclosure, an eNB may be used interchangeably with a gNB for convenience of description. That is, a base station described as an eNB may represent a gNB. Further, the term ‘terminal’ may represent other wireless communication devices as well as mobile phones, NB-IOT devices, and sensors.

A wireless communication system is being evolved from providing voice-oriented services in the early days to a broadband wireless communication system that provides high-speed and high-quality packet data services as in communication standards such as high speed packet access (HSPA), long term evolution (LTE) or evolved universal terrestrial radio access (E-UTRA), LTE-Advanced (LTE-A), and LTE-Pro of 3GPP, high rate packet data (HRPD) and ultra mobile broadband (UMB) of 3GPP2, and IEEE 802.16e.

An LTE system as a representative example of the broadband wireless communication system employs an orthogonal frequency division multiplexing (OFDM) scheme in downlink (DL) and employs a single carrier frequency division multiple access (SC-FDMA) scheme in uplink. The uplink means a radio link in which a user equipment (UE) or a mobile station (MS) transmits data or control signals to an eNode B (eNB) or a base station (BS), and the downlink means a radio link in which a base station transmits data or control signals to a UE. The above-described multiple access scheme may enable data or control information of each user to distinguish by allocating and operating data or control information so that time-frequency resources to carry data or control information for each user do not overlap each other, that is, so that orthogonality is established.

A 5G communication system as a future communication system after LTE should support services that simultaneously satisfy various requirements because various requirements of users and service providers may be freely reflected. Services considered for the 5G communication system include enhanced mobile broadband (eMBB), massive machine type communication (mMTC), ultra reliability low latency communication (URLLC), and the like.

According to some embodiments, the eMBB aims to provide a more improved data rate than a data rate supported by existing LTE, LTE-A, or LTE-Pro. For example, in the 5G communication system, the eMBB should be able to provide a peak data rate of 20 Gbps in downlink and a peak data rate of 10 Gbps in uplink from the viewpoint of one base station. Further, the 5G communication system should be able to provide an increased user perceived data rate of a UE while providing a peak data rate. In order to satisfy such requirements, in the 5G communication system, it may be required to improve various transmission and reception technologies, including more advanced multi input and multi output (MIMO) transmission technology. Further, the current LTE system transmits a signal using a transmission bandwidth of maximum 20 MHz in the 2 GHz band, whereas the 5G communication system can satisfy a data rate required by the same by using a frequency bandwidth wider than 20 MHz in a frequency band of 3 to 6 GHz or 6 GHz or more.

At the same time, in the 5G communication system, mMTC is being considered to support application services such as Internet of Things (IOT). In order to efficiently provide IoT, mMTC may require access support for large-scale UEs within a cell, improved coverage of UEs, improved battery time, and reduced UE cost. Because IT is attached to various sensors and various devices to provide communication functions, it should be able to support a large number of UEs (e.g., 1,000,000 UEs/km²) in a cell. Further, because a UE supporting mMTC is likely to be positioned in a shadow area that is not covered by a cell, such as the basement of a building due to the nature of the service, the UE may require wider coverage than other services provided by the 5G communication system. The UE supporting mMTC should be composed of a low-cost UE, and because it is difficult to frequently replace a battery of the UE, a very long battery life time such as 10 to 15 years may be required.

Finally, URLLC is a cellular-based wireless communication service to be used for mission-critical and may be used for a service used in remote control for a robot or machine, industrial automation, an unmanned aerial vehicle, remote health care, emergency alert and the like. Therefore, communication providing URLLC should be able to provide very low latency (ultra-low latency) and very high reliability (ultra-reliability). For example, a service supporting URLLC should satisfy air interface latency smaller than 0.5 milliseconds and may simultaneously have the requirement of a packet error rate of 10⁻⁵ or less. Therefore, for a service supporting URLLC, the 5G system should provide a transmit time interval (TTI) smaller than that of other services, and may require a design requirement that should simultaneously allocate a wide resource in a frequency band in order to secure reliability of a communication link.

Three services, i.e., eMBB, URLLC, and mMTC considered in the above-described 5G communication system may be multiplexed and transmitted in a single system. In this case, in order to satisfy different requirements of each service, different transmission and reception techniques and transmission and reception parameters may be used between services. However, the above-described mMTC, URLLC, and eMBB are only examples of different service types, and the service types to which the disclosure is applied are not limited to the above-described examples.

Hereinafter, although embodiments of the disclosure are described using LTE, LTE-A, LTE pro, or 5G (or NR, next generation mobile communication) system as an example, embodiments of the disclosure may be applied to other communication systems having a similar technical background or channel type. Further, embodiments of the disclosure may be applied to other communication systems through some modifications within a range that does not significantly deviate from the scope of the disclosure by the determination of a person having skilled technical knowledge.

Hereinafter, an operating principle of the disclosure will be described in detail with reference to the accompanying drawings. In the following description, in describing the disclosure, in the case that it is determined that a detailed description of a related well-known function or constitution may unnecessarily obscure the gist of the disclosure, a detailed description thereof will be omitted. Terms described below are terms defined in consideration of functions in the disclosure, which may vary according to intentions or customs of users and operators. Therefore, the definition should be made based on the content throughout this specification.

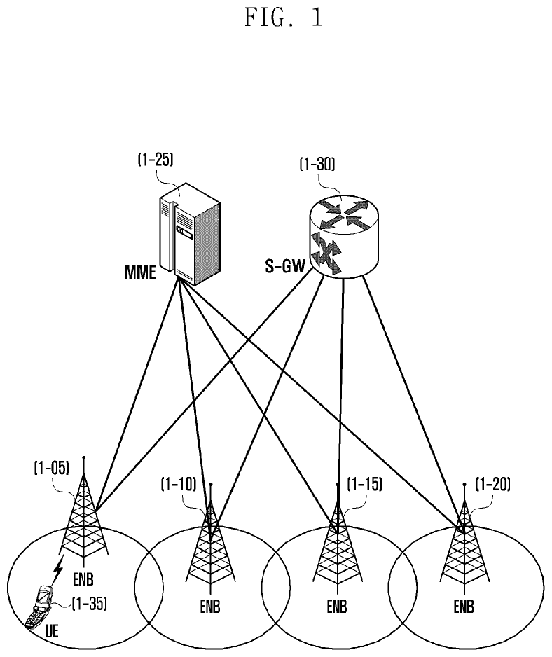

FIG. 1 is a diagram illustrating a structure of an existing LTE system.

With reference to FIG. 1, as illustrated, a radio access network of the LTE system may include an evolved node B (hereinafter, ENB, node B, or base station) 1-05, 1-10, 1-15, and 1-20, a mobility management entity (MME) 1-25, and a serving-gateway (S-GW) 1-30. A user equipment (hereinafter, UE or terminal) 1-35 may access an external network through the ENBs 1-05 to 1-20 and the S-GW 1-30.

In FIG. 1, the ENBs 1-05 to 1-20 may correspond to the existing node B of an UMTS system. The ENB may be connected to the UE 1-35 through a radio channel and perform a more complex role than that of the existing Node B. In the LTE system, all user traffic including real-time services such as a voice over IP (VOIP) through an Internet protocol may be serviced through a shared channel. Therefore, a device for collecting and scheduling status information such as a buffer status, available transmission power status, and channel status of UEs is required, and the ENBs 1-05 to 1-20 may be in charge of this. One ENB may usually control multiple cells. For example, in order to implement a transmission rate of 100 Mbps, an LTE system may use orthogonal frequency division multiplexing (OFDM) as radio access technology in, for example, a 20 MHz bandwidth. Further, an adaptive modulation & coding (AMC) scheme for determining a modulation scheme and a channel coding rate according to a channel status of the UE may be applied. The S-GW 1-30 is a device that provides data bearer, and may create or remove data bearer under the control of the MME 1-25. The MME is a device in charge of various control functions as well as a mobility management function for a UE, and may be connected to a plurality of base stations.

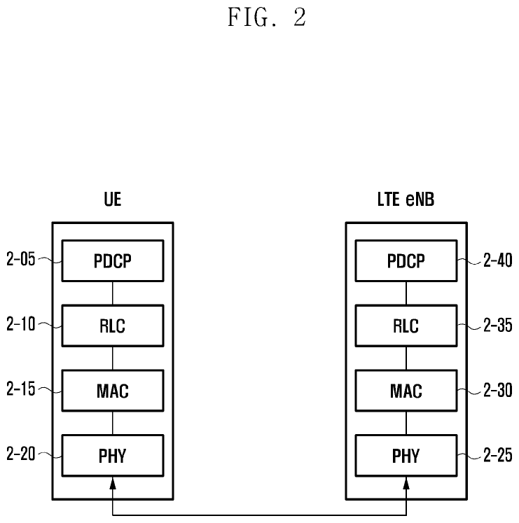

FIG. 2 is a block diagram illustrating a radio protocol structure of an LTE system according to an embodiment of the disclosure.

With reference to FIG. 2, radio protocols of the LTE system may include packet data convergence protocols (PDCP) 2-05 and 2-40, radio link controls (RLC) 2-10 and 2-35, and medium access controls (MAC) 2-15 and 2-30 in the UE and the ENB, respectively. The PDCP may be in charge of operations such as IP header compression/restoration. Main functions of the PDCP may be summarized as follows.
Header compression and decompression: ROHC(Robust Header Compression) only
Transfer of user data
In-sequence delivery of upper layer PDUs (Protocol Data Units) at PDCP (Packet Data Convergence Protocol) re-establishment procedure for RLC(Radio Link Control) AM (Acknowledged Mode)
For split bearers in DC (Dual Connectivity)(only support for RLC AM): PDCP PDU routing for transmission and PDCP PDU reordering for reception
Duplicate detection of lower layer SDUs at PDCP re-establishment procedure for RLC AM
Retransmission of PDCP SDUs at handover and, for split bearers in DC, of PDCP PDUs at PDCP data-recovery procedure, for RLC AM
Ciphering and deciphering
Timer-based SDU discard in uplink.

The radio link controls (RLCs) 2-10 and 2-35 may reconstitute the PDCP packet data unit (PDU) into an appropriate size and perform an automatic repeat request (ARQ) operation. Main functions of the RLC may be summarized as follows.
Transfer of upper layer PDUs
Error Correction through ARQ (only for AM data transfer)
Concatenation, segmentation and reassembly of RLC SDUs (only for UM and AM data transfer)
Re-segmentation of RLC data PDUs (only for AM data transfer)
Reordering of RLC data PDUs (only for UM and AM data transfer
Duplicate detection (only for UM and AM data transfer)
Protocol error detection (only for AM data transfer)
RLC SDU discard (only for UM (Unacknowledged mode) and AM data transfer)
RLC re-establishment

The MACs 1b-15 and 1b-30 may be connected to several RLC layer devices constituted in one UE, and perform operations of multiplexing RLC PDUs to MAC PDUs and demultiplexing RLC PDUs from MAC PDUs. Main functions of the MAC may be summarized as follows.
Mapping between logical channels and transport channels
Multiplexing/demultiplexing of MAC SDUs belonging to one or different logical channels into and from transport blocks (TB) delivered to and from the physical layer on transport channels
Scheduling information reporting
Error correction through HARQ (Hybrid Automatic Repeat Request)
Priority handling between logical channels of one UE
Priority handling between UEs by means of dynamic scheduling
MBMS (Multimedia Broadcast and Multicast Service) service identification
Transport format selection
Padding

Physical layers 2-20 and 2-25 may perform operations of channel-coding and modulating upper layer data, making the upper layer data into OFDM symbols and transmitting the OFDM symbols through a radio channel, or demodulating and channel-decoding OFDM symbols received through a radio channel and transmitting the OFDM symbols to the upper layer.

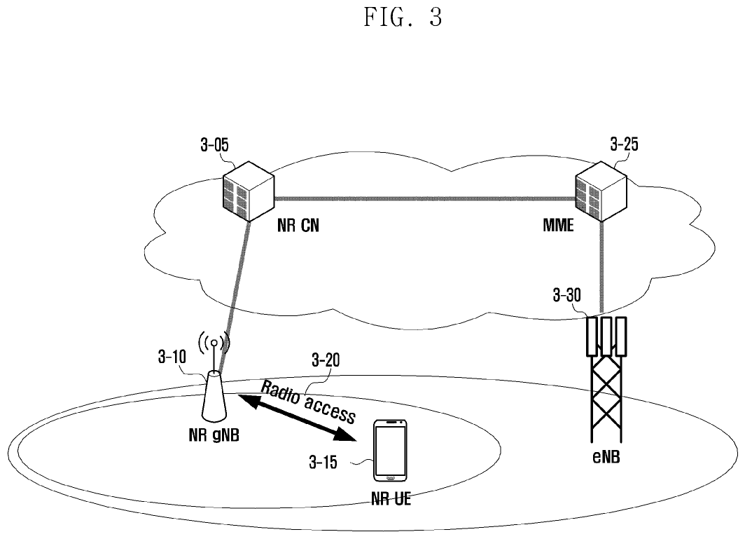

FIG. 3 is a diagram illustrating a structure of a next generation mobile communication system according to an embodiment of the disclosure.

With reference to FIG. 3, a radio access network of a next generation mobile communication system (hereinafter, NR or 5G) may include a new radio node B (hereinafter, NR gNB or NR base station) 3-10 and a new radio core network (NR CN) 3-05. A new radio user equipment (NR UE or UE) 3-15 may access an external network through the NR gNB 3-10 and the NR CN 3-05.

In FIG. 3, the NR gNB 3-10 may correspond to an evolved Node B (eNB) of the existing LTE system. The NR gNB may be connected to the NR UE 3-15 through a radio channel and provide a superior service to that of the existing Node B. In a next generation mobile communication system, all user traffic may be serviced through a shared channel. Therefore, a device for collecting and scheduling status information such as a buffer status, available transmission power status, and channel status of UEs is required, and the NR gNB 3-10 may in charge of this. One NR gNB may control multiple cells. In a next generation mobile communication system, in order to implement ultrahigh speed data transmission compared to the current LTE, a bandwidth higher than the current maximum bandwidth may be applied. Further, beamforming technology may be additionally applied using orthogonal frequency division multiplexing (OFDM) as radio access technology. Further, an adaptive modulation & coding (hereinafter, referred to as AMC) scheme of determining a modulation scheme and a channel coding rate according to a channel status of the UE may be applied.

The NR CN 3-05 may perform functions such as the mobility support, a bearer configuration, and a QoS configuration. The NR CN is a device in charge of various control functions as well as a mobility management function for the UE, and may be connected to a plurality of base stations. Further, the next generation mobile communication system may be interworked with the existing LTE system, and the NR CN may be connected to an MME 3-25 through a network interface. The MME may be connected to an eNB 3-30, which is an existing base station.

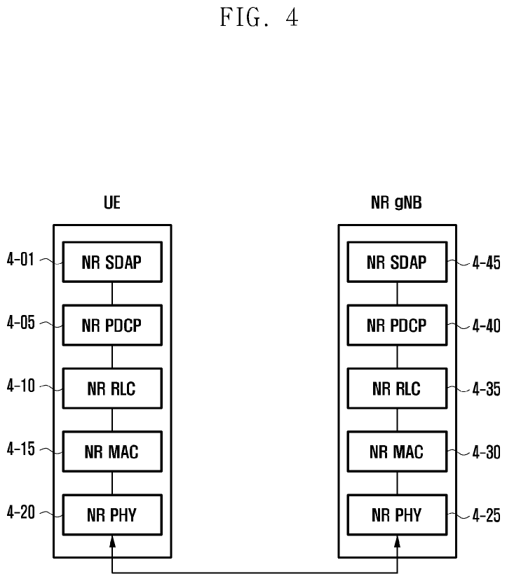

FIG. 4 is a block diagram illustrating a radio protocol structure of a next generation mobile communication system according to an embodiment of the disclosure.

With reference to FIG. 4, radio protocols of the next generation mobile communication system may include NR service data adaptation protocols (SDAP) 4-01 and 4-45, NR PDCPs 4-05 and 4-40, NR RLCs 4-10 and 4-35, NR MACs 4-15 and 4-30, and NR PHYs 4-20 and 4-25 in the UE and the NR base station, respectively.

Main functions of the NR SDAPs 4-01 and 4-45 may include some of the following functions.
transfer of user plane data
mapping between a QoS flow and a DRB for both DL (Down Link) and UL (Up Link)
marking QoS flow ID in both DL and UL packets
reflective QoS flow to DRB mapping for the UL SDAP PDUs.

For the SDAP layer device, the UE may receive a configuration on whether to use a header of the SDAP layer device or to use a function of the SDAP layer device for each PDCP layer device, for each bearer, or for each logical channel by a radio resource control (RRC) message received from the base station. In the case that the SDAP header is configured, the UE may instruct to update or reconfigure mapping information for uplink and downlink QoS flows and data bearers using a non-access stratum (NAS) quality of service (QOS) reflection configuration 1-bit indicator (NAS reflective QoS) of the SDAP header and access stratum (AS) QoS reflection configuration 1 bit indicator (AS reflective QoS). The SDAP header may include QoS flow ID information indicating a QoS. QoS information may be used as a data processing priority and scheduling information for supporting a smooth service.

Main functions of the NR PDCPs 4-05 and 4-40 may include some of the following functions.
Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink.

In the above description, reordering of the NR PDCP device may mean reordering PDCP PDUs received from a lower layer based on a PDCP sequence number (SN). The reordering of the NR PDCP device may include a function of transferring data to a higher layer in the rearranged order, a function of directly transferring data without considering the order, a function of recording lost PDCP PDUs by rearranging the order, a function of reporting a status of lost PDCP PDUs to the transmitting side, and a function of requesting retransmission of lost PDCP PDUs.

Main functions of the NR RLCs 4-10 and 4-35 may include some of the following functions.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

In the above description, in-sequence delivery of the NR RLC device may mean a function of sequentially transferring RLC SDUs received from a lower layer to an upper layer. In the case that one RLC SDU is originally divided into several RLC SDUs and received, in-sequence delivery of the NR RLC device may include a function of reassembling and transferring the several RLC SDUs.

In-sequence delivery of the NR RLC device may include a function of rearranging received RLC PDUs based on an RLC sequence number (SN) or a PDCP sequence number (SN), a function of rearranging the order and recording lost RLC PDUs, a function of reporting a status of lost RLC PDUs to the transmitting side, and a function of requesting retransmission of lost RLC PDUs.

In-sequence delivery of the NR RLC device may include a function of sequentially transferring, in the case that there is a lost RLC SDU, only RLC SDUs prior to the lost RLC SDU to a higher layer.

In-sequence delivery of the NR RLC device may include a function of sequentially transferring all RLC SDUs received before the timer starts to the upper layer, if a predetermined timer expires even if there is a lost RLC SDU.

In-sequence delivery of the NR RLC device may include a function of sequentially transferring all RLC SDUs received so far to the higher layer, if a predetermined timer expires even if there is a lost RLC SDU.

The NR RLC device may process RLC PDUs in the order in which they are received regardless of the order of sequence numbers (out-of sequence delivery) and transfer the RLC PDUs to the NR PDCP device.

In the case that the NR RLC device receives a segment, the NR RLC device may receive segments stored in a buffer or to be received later, reconstitute segments into one complete RLC PDU, and then transfer the one complete RLC PDU to the NR PDCP device.

The NR RLC layer may not include a concatenation function, and the NR MAC layer may perform a concatenation function or a function of the NR RLC layer may be replaced with a multiplexing function of the NR MAC layer.

In the above description, out-of-sequence delivery of the NR RLC device may mean a function of directly transferring RLC SDUs received from a lower layer to an upper layer regardless of order. Out-of-sequence delivery of the NR RLC device may include a function of reassembling and transferring several RLC SDUs in the case that one RLC SDU is originally divided into several RLC SDUs and received. The out-of-sequence delivery of the NR RLC device may include a function of storing RLC SNs or PDCP sequence numbers (SNs) of received RLC PDUs, arranging the order, and recording lost RLC PDUs.

The NR MACs 4-15 and 4-30 may be connected to several NR RLC layer devices constituted in one UE, and main functions of the NR MAC may include some of the following functions.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

The NR PHY layers 4-20 and 4-25 may perform operations of channel-coding and modulating higher layer data, making the higher layer data into OFDM symbols and transmitting the OFDM symbols through a radio channel, or demodulating OFDM symbols received through a radio channel, channel-decoding the OFDM symbols, and transferring the OFDM symbols to a higher layer.

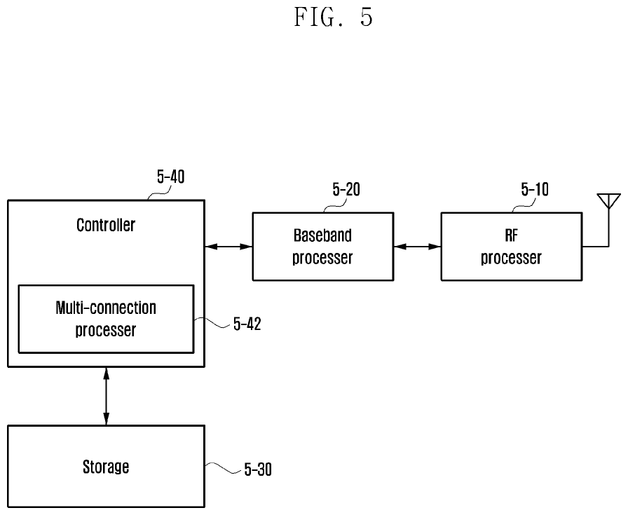

FIG. 5 is a block diagram illustrating an internal structure of a UE according to an embodiment of the disclosure.

With reference to FIG. 5, the UE includes a radio frequency (RF) processer 5-10, a baseband processer 5-20, a storage 5-30, and a controller 5-40.

The RF processer 5-10 performs a function for transmitting and receiving signals through a wireless channel, such as band conversion and amplification of signals. That is, the RF processer 5-10 up-converts a baseband signal provided from the baseband processer 5-20 into an RF band signal, transmits the RF band signal through an antenna, and down-converts the RF band signal received through the antenna into a baseband signal. For example, the RF processor 5-10 may include a transmission filter, a reception filter, an amplifier, a mixer, an oscillator, a digital to analog converter (DAC), an analog to digital converter (ADC), and the like. In FIG. 5, only one antenna is illustrated, but the UE may have multiple antennas. Further, the RF processer 5-10 may include a plurality of RF chains. Furthermore, the RF processor 5-10 may perform beamforming. For beamforming, the RF processor 5-10 may adjust a phase and magnitude of each of signals transmitted and received through a plurality of antennas or antenna elements. Further, the RF processor 5-10 may perform multiple-input and multiple-output (MIMO), and receive several layers when performing the MIMO operation.

The baseband processer 5-20 performs a conversion function between a baseband signal and a bit string according to the physical layer standard of the system. For example, when transmitting data, the baseband processor 5-20 encodes and modulates a transmission bit string to generate complex symbols. Further, when receiving data, the baseband processer 5-20 demodulates and decodes the baseband signal provided from the RF processer 5-10 to restore the received bit string. For example, when transmitting data according to an orthogonal frequency division multiplexing (OFDM) scheme, the baseband processor 5-20 encodes and modulates a transmission bit string to generate complex symbols, maps the complex symbols to subcarriers, and then constitutes OFDM symbols through inverse fast Fourier transform (IFFT) operation and cyclic prefix (CP) insertion. Further, when receiving data, the baseband processer 5-20 divides the baseband signal provided from the RF processer 5-10 into OFDM symbol units, restores signals mapped to subcarriers through fast Fourier transform (FFT), and then restores the received bit string through demodulation and decoding.

The baseband processer 5-20 and the RF processer 5-10 transmit and receive signals, as described above. Accordingly, the baseband processer 5-20 and the RF processer 5-10 may be referred to as a transmitter, a receiver, a transceiver, or a communication unit. Furthermore, at least one of the baseband processer 5-20 and the RF processer 5-10 may include a plurality of communication modules in order to support a plurality of different radio access technologies. Further, at least one of the baseband processor 5-20 and the RF processor 5-10 may include different communication modules in order to process signals of different frequency bands. For example, different radio access technologies may include a wireless LAN (e.g., IEEE 802.11), a cellular network (e.g., LTE), and the like. Further, the different frequency bands may include a super high frequency (SHF) (e.g., 2.NRHz, NRhz) band and a millimeter wave (e.g., 60 GHz) band.

The storage 5-30 stores data such as a basic program, an application program, and configuration information for operation of the UE. In particular, the storage 5-30 may store information related to a second access node performing wireless communication using second wireless access technology. The storage 5-30 provides the stored data according to the request of the controller 5-40.

The controller 5-40 controls overall operations of the UE. For example, the controller 5-40 transmits and receives signals through the baseband processor 5-20 and the RF processor 5-10. Further, the controller 5-40 writes and reads data in the storage 5-40. To this end, the controller 5-40 may include at least one processor. For example, the controller 5-40 may include a communication processor (CP) that controls communication and an application processor (AP) that controls upper layers such as application programs. Further, the controller 5-40 may include a multi-connection processer 5-42 that performs processing in the case that the UE operates in multi-connections.

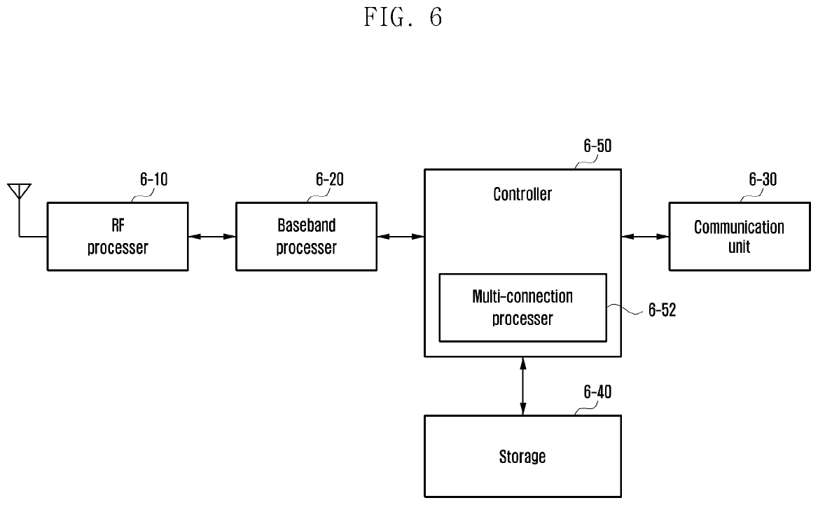

FIG. 6 is a block diagram illustrating a constitution of a base station according to an embodiment of the disclosure.

As illustrated in FIG. 6, the base station includes an RF processer 6-10, a baseband processer 6-20, a communication unit 6-30, a storage 6-40, and a controller 6-50.

The RF processer 6-10 performs a function for transmitting and receiving signals through a wireless channel, such as band conversion and amplification of signals. That is, the RF processer 6-10 up-converts a baseband signal provided from the baseband processer 6-20 into an RF band signal, transmits the RF band signal through an antenna, and down-converts the RF band signal received through the antenna into a baseband signal. For example, the RF processor 6-10 may include a transmission filter, a reception filter, an amplifier, a mixer, an oscillator, a DAC, an ADC, and the like. In FIG. 6, only one antenna is illustrated, but a first connection node may have multiple antennas. Further, the RF processer 6-10 may include a plurality of RF chains. Furthermore, the RF processor 6-10 may perform beamforming. For beamforming, the RF processer 6-10 may adjust a phase and size of each of signals transmitted and received through a plurality of antennas or antenna elements. The RF processer may transmit one or more layers to perform a downlink MIMO operation.

The baseband processor 6-20 performs a conversion function between a baseband signal and a bit string according to the physical layer standard of first radio access technology. For example, when transmitting data, the baseband processor 6-20 encodes and modulates a transmission bit string to generate complex symbols. Further, when receiving data, the baseband processer 6-20 demodulates and decodes a baseband signal provided from the RF processer 6-10 to restore a received bit string. For example, when transmitting data according to an OFDM scheme, the baseband processer 6-20 encodes and modulates a transmission bit string to generate complex symbols, maps the complex symbols to subcarriers, and constitutes OFDM symbols through an IFFT operation and CP insertion. Further, when receiving data, the baseband processer 6-20 divides the baseband signal provided from the RF processer 6-10 into OFDM symbol units, restores signals mapped to subcarriers through FFT operation, and restores the received bit string through demodulation and decoding. The baseband processer 6-20 and the RF processer 6-10 transmit and receive signals, as described above. Accordingly, the baseband processer 6-20 and the RF processer 6-10 may be referred to as a transmitter, a receiver, a transceiver, a communication unit, or a RF unit.

The communication unit 6-30 may serve as a backhaul communication unit for providing an interface for communicating with other nodes in the network. That is, the communication unit 6-30 converts a bit string transmitted from a main base station to another node, for example, a secondary base station, and a core network into a physical signal, and converts a physical signal received from another node into a bit string.

The storage 6-40 stores data such as a basic program, an application program, and configuration information for operation of the main base station. In particular, the storage 6-40 may store information on bearers allocated to the accessed UE, measurement results reported from the accessed UE, and the like. Further, the storage 6-40 may store information to be a criterion for determining whether to provide or stop multiple connections to the UE. The storage 6-40 provides the stored data according to the request of the controller 6-50.

The controller 6-50 controls overall operations of the main base station. For example, the controller 6-50 may transmit and receive signals through the baseband processer 6-20 and the RF processer 6-10 or through the communication unit 6-30. Further, the controller 6-50 writes and reads data in the storage 6-40. To this end, the controller 6-50 may include at least one processor. Further, the controller 6-50 may include a multi-connection processer 6-42 for processing in the case that a corresponding base station operates in multiple connections.

Related operations of features of the disclosure described below may be performed according to the above-described functions of each component included in the UE of FIG. 5 and the base station of FIG. 6.

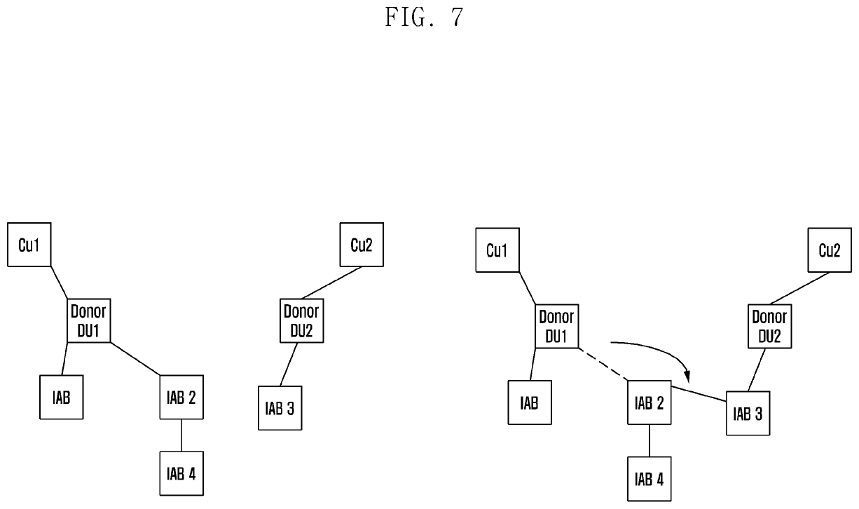

FIG. 7 illustrates topology information according to an embodiment of the disclosure.

An IAB node 2 (IAB 2) intends to move to be connected to an IAB node3 (IAB 3) connected to a donor DU2 connected to a CU2 while being connected to a donor DU1 connected to a CU1. In this case, uplink backhaul adaptation protocol (BAP) PDUs have been previously buffered or discarded during handover (HO), but by the method proposed in the disclosure, the uplink backhaul adaptation protocol (BAP) PDUs may be connected to the donor DU2 and CU2 and transmitted through a target path, that is, the IAB node 3.

The IAB node may first specify buffering. The UE buffers the BAP PDU in a buffer of a transmitting part of a BAP entity until an RLC-AM entity receives an ACK. Additionally, after performing RRC migration, the IAB node should operate to configure routing to a target DU for UL packets buffered and/or not matched to routing entry. The following two methods are possible for this purpose.

Opt 1. Use Default UL config for F1-U or

Opt 2. Reconfigure or rewrite a routing ID of a packet header

Configuration information corresponding to the above two cases may be included in an RRCReconfiguration message (or HO command message) and transferred to the migrating IAB node during migration.

Further, BAP mapping configuration information received from the target CU may be transferred after HO complete (transfer RRCReconfigurationComplete to the target) through an FIC or F1 application protocol (F1AP) signal or may be included in the HO command and transferred.

Information included in the BAP mapping configuration message is as follows.

BH Routing Information Added List: pair of BAP routing Id and next hop BAP address, and a routing table is composed with this information.

Traffic Mapping Information IE: There is the following two sub information.

IP to Layer 2 Traffic Mapping Info: IP to BAP routing ID, and for the UL BAP PDU generated in the IAB node itself, this information maps an IP address of the upper layer to the BAP routing ID and uses header information of the BAP PDU.

BAP layer BH RLC channel mapping Info IE: Information that allocates a BH RLC CH for UL BAP PDUs generated in the IAB node itself.

Further, through the F1AP, the following information may be received.
Uplink Traffic to Routing ID Mapping Configuration.
Downlink Traffic to Routing ID Mapping Configuration.
BH Routing Configuration.
BH RLC Channel Mapping Configuration.
Uplink Traffic to BH RLC Channel Mapping Configuration.
Downlink Traffic to BH RLC Channel Mapping Configuration.

In this disclosure, in an embodiment through the F1AP or another embodiment, it is assumed that a BAP mapping configuration included in the HO command includes all of the above information.

The migrating IAB node may perform different operations for each case.

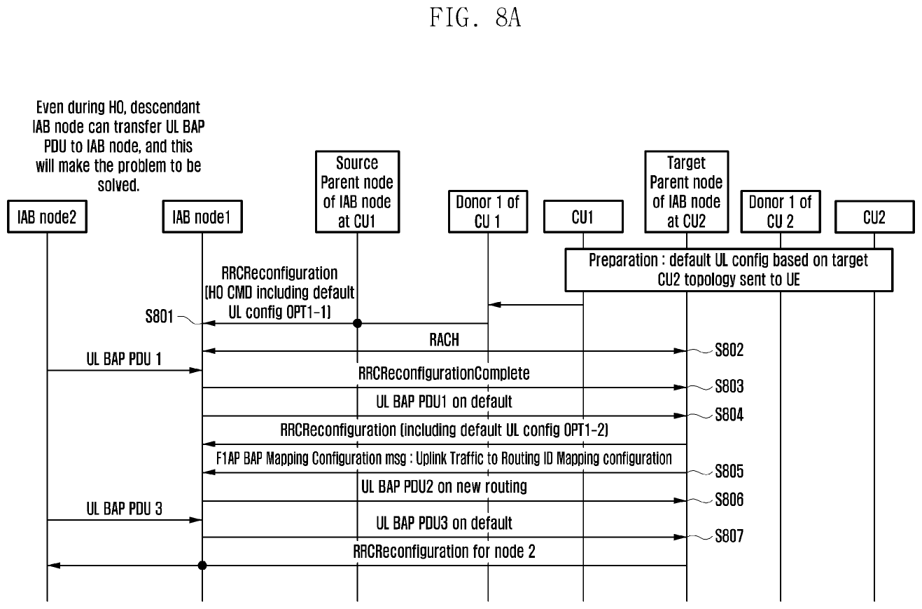

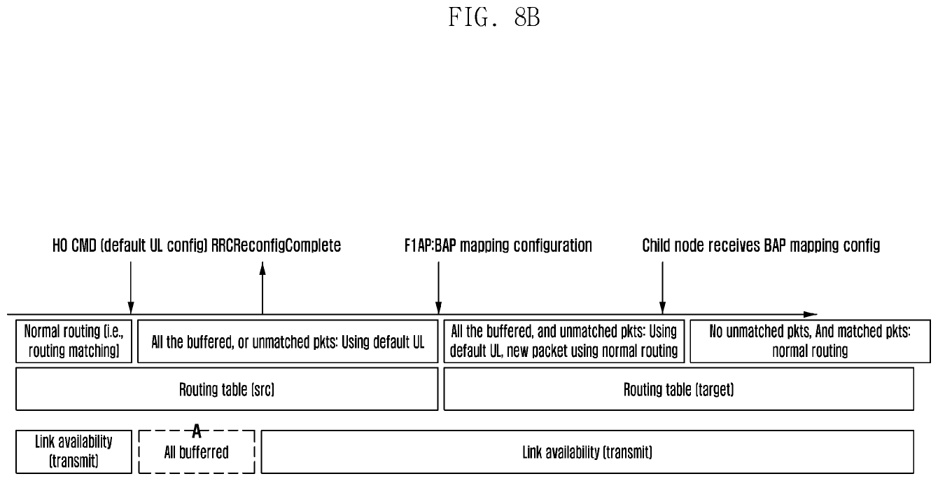

FIGS. 8A and 8B illustrate the case that a default UL configuration is included in the HO command message and transferred and that a BAP mapping configuration is transferred to an F1AP after HO complete.

In the case of inter-donor migration, when a source donor transmits a HO request message including a target parent node or corresponding target cell information to a target donor, in the case that the target donor performs admission and considers a target cell as the parent, the target donor may transmit default UL configuration information reflecting topology information thereof to the source donor, and the source donor may transmit a handover (HO) command (RRCReconfiguration message) including default UL configuration information to a migrating IAB node (S801). Here, the default UL configuration information may include the following information.
defaultUL-BAP-RoutingID-F1U: As a routing ID considering a target path, the defaultUL-BAP-RoutingID-F1U may be a BAP address of a target donor DU and a path ID up to the corresponding destination. The defaultUL-BAP-RoutingID-F1U may be used for non-F1-U or/and F1-U traffic.
defaultUL-BH-RLC-channel-F1U: As a BH RLC channel considering a target path, the defaultUL-BH-RLC-channel-F1U may be a BH RLC channel configured in a link on the default-BAP-routing ID-FIU. The defaultUL-BH-RLC-channel-F1U may be used for non-F1-U or/and F1-U traffic.
Available timer: time maintained after the default UL configuration information is applied

In FIG. 8A, when the source donor transmits an HO request message including a target parent node or corresponding target cell information to the target donor, in the case that the target donor performs admission and considers the target cell as a parent, the target donor may transmit default UL configuration information reflecting topology information thereof to the source donor, and the source donor may transmit the HO command (RRCReconfiguration message) including the default UL configuration information to the migrating IAB node.

The migrating IAB node (IAB node 1) that has received the message performs random access (S802), and if random access is successful, the migrating IAB node (IAB node 1) transmits an RRCReconfigurationComplete message to the target IAB node (target parent node of IAB node at CU2) (S803). When the target CU (CU2) recognizes that the migrating IAB node succeeded in HO, the target CU (CU2) may update routing configurations on all IAB nodes to the target IAB node to configurations including the migrating IAB node. Further, BAP mapping configuration and routing configuration information reflecting new CU2 topology on the F1AP may be transmitted to the migrating IAB node.

When a BAP PDU 1 having an old routing ID is transmitted from a node 2 (IAB node 2), which is a child node to the IAB node 1 after receiving a HO command (CMD) of the IAB node 1, the situation is a situation before a BAP mapping configuration & routing configuration on the F1AP is transmitted to the IAB node 1; thus, the BAP PDU 1 is UL transmitted through the target path by applying default UL configurations (S804). After an F1AP BAP mapping config & routing config is received in the IAB node 1 (S805), when the BAP PDU 2 is generated in the migrating IAB node, the BAP PDU 2 is transmitted by applying new routing information given in the target (S806). Finally, even after applying a BAP mapping config & routing config through an F1AP signal, a BAP PDU 3 based on the old routing id may be received from the child node, and in this case, because the BAP PDU 3 does not match routing entry received from the target, the BAP PDU 3 is UL transmitted by applying a default UL configuration (S807).

As another example, default UL configuration information may be transferred through an RRCReconfiguration message first received after HO complete, rather than through a HO CMD. In this case, from a time point of receiving the default UL configuration information, BAP PDUs that are buffered or unmatched to the current routing entry are transmitted using the default UL.

FIG. 8B illustrates temporal arrival of each configuration information and the corresponding operation of a migrating IAB node.

0. The UE may receive a HO command from the source CU while performing a general routing operation using configuration information included in BAP mapping configuration received from the source CU. The HO command message may include default UL for F1U configuration information.

1. The UE receives a HO CMD (handover command or RRCReconfiguration message including reconfigurationWithSync), and by default UL for F1-U configuration,
headers of all unmatched BAP PDUs (that do not match any of the current routing entries) received from now on (and/or awaiting transmission); and/or
headers of all buffered BAP PDUs,
modifies to a routing id of default UL configuration information (5.2.1.2.1 BAP routing ID selection at IAB-node). That is, the UE performs header rewriting.
Modify to the BH RLC CH of default UL configuration information (5.2.1.4.2 Mapping to BH RLC Channel for BAP SDUs from upper layers at IAB-node). That is, the UE allocates a new BH RLC CH for the header rewritten BAP SDU
perform again routing of the BAP PDU to which Default UL configuration information is applied. That is, the UE selects an egress link based on the routing id of the default UL configuration information and selects an egress BH RLC CH on default UL configuration information in the corresponding egress link (5.2.1.3 Routing).
Transfer to the lower layer for transmission to the selected BH RLC CH of the egress link.

2. Even if the default UL configuration is used, the link is unavailable until transmission of RRCReconfigComplete, and may still be buffered during that period.
If a section A illustrated in FIG. 8B is ignored, there is no buffered packet. If a section A is not ignored, a buffered packet exists, and when link availability is restored (i.e., during RRCReconfigComplete), an operation of rerouting a buffered packet to the default UL may be required.

3. After transmission of HO complete (RRCReconfigurationcomplete), it is possible to start transmission to the default UL link without following the current routing table.

4. After receiving the F1AP BAP mapping configuration, a routing configuration is reflected to the target path. However, among the UL BAP PDUs received by the migrating IAB node until a specific time, there may be unmatched packets that are not appropriate for new routing entry, and the unmatched packets are transmitted according to the default UL. In this case, packet header rewriting may be performed for each packet through the routing ID and BH RLC channel allocation performed above. Further, a new BAP SDU may be generated in the migrating IAB node, and be transferred along new routing (if there is unmatched UL BAP PDU with the current routing entry, then use default UL config FIU for them even “Uplink Traffic to Routing ID Mapping Configuration” has been (re)configured by F1-AP.)
Previously, when an FAP BAP mapping config was received, the default UL was not followed.

5. When the corresponding timer expires according to a specific timer value, the use of the default UL configuration may be stopped. Alternatively, the network may provide an RRC reconfig message for releasing the corresponding default UL config.

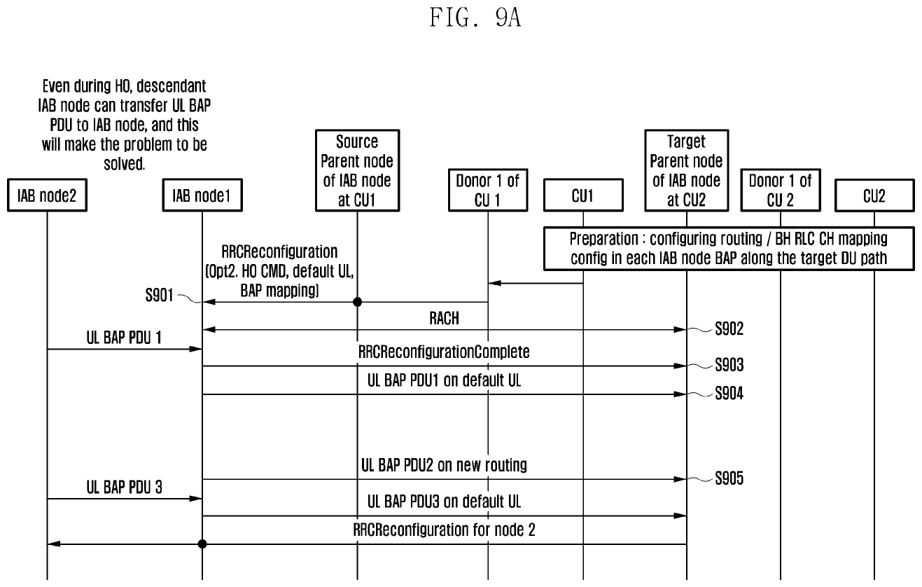

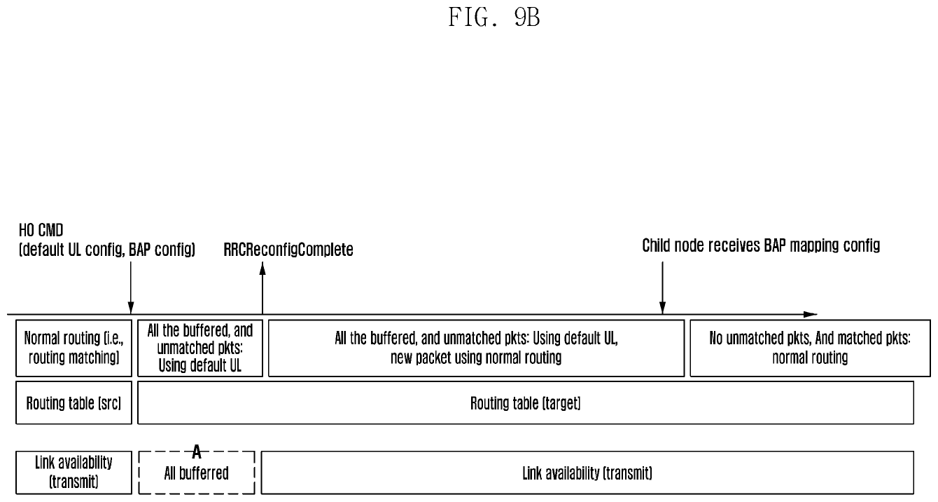

FIG. 9A illustrates the case that a default UL configuration, a BAP mapping configuration, and a routing configuration are all transferred to a HO command message.

With reference to FIG. 9A, a source donor may transmit a HO command (RRCReconfiguration message) to a migrating IAB node (IAB node 1) (S901). Here, the RRCReconfiguration message may include a HO command, default UL configuration, and BAP mapping configuration information. Here, the BAP mapping configuration information may include BAP mapping configuration and routing configuration information reflecting the topology of a new CU2.

The migrating IAB node (IAB node 1) that has received the message performs random access (S902) and if random access is successful, the migrating IAB node (IAB node 1) transmits an RRCReconfigurationComplete message to the target IAB node (target parent node of IAB node at CU2) (S903). Thereafter, when a BAP PDU 1 that does not match the routing entry is received from a child node, the migrating IAB node (IAB node 1) may transmit the BAP PDU 1 based on the default UL configuration (S904). Alternatively, a UL BAP PDU 2 generated in the migrating IAB node may be transmitted by applying the previously received BAP mapping and routing configuration (S905). FIG. 9B illustrates an operation of the migrating IAB node in time in the case of 9A.

The moment the migrating IAB node receives a HO command, the routing configuration including the routing entry applies what was configured from the target CU. The migrating IAB node may receive unmatched BAP PDUs from the child node in the routing entry received from a current target. UL BAP PDUs buffered in this way or unmatched to the current routing entry are transmitted to the target path through a BAP PDU header rewriting by applying the default UL configuration. Because a detailed description thereof is the same as an operation of applying the default UL described above with reference to FIGS. 8A and 8B, duplicate descriptions will be omitted. At the same time, by applying a configuration to a target path through the BAP mapping and routing configurations received from the HO CMD, a routing ID is allocated and a BH RLC CH is allocated, and UL BAP SDUs generated in the migrating IAB node are transferred to the determined target path through routing.

Because the target link becomes available after transmission of the complete message, it is possible to transmit a packet written and buffered to the existing default UL in RLC. In this case, default UL transmission through new link selection is possible.

In the case that the child node receives a routing config on a new F1AP and all BAP headers include a new routing id, the migrating IAB node may determine that there is no more unmatched UL BAP PDU and use normal routing for all packets.

Even in this case, there is a timer value for using the default UL configuration, and the default UL for F1U may be used only until the corresponding time.

In the case of using default UL in FIGS. 8A, 8B, 9A, and 9B, the target donor CU may receive old routing Id information to which a migrating IAB node and descendant IAB nodes thereof allocate for UL BAP PDUs from the source donor CU through a HO request message, add information mapping a new routing ID to the HO command message with respect to the corresponding routing ID and a related IAB node, and transmit again the HO command message to the source donor CU. This information is referred to as BAP header change configuration information. The source CU may transmit the HO command including the BAP header change configuration information to the migrating IAB node.

Here, the BAP header change configuration information may include the following contents:
a list of BAP routing ID update information: each item includes pair of {old BAP routing ID and new BAP routing ID to be replaced with}. This is applied to each packet impacted by the migration individually and used for packet re-routing to the new destination.
BH RLC CH list for each BAP PDU with old routing id
Timer value to apply the information:

The IAB MT that has received this information performs the corresponding routing ID change procedure during a determined time period.

The migrating IAB node that has received the above information rewrites a BAP header of all PDUs having an old BAP routing ID in the above list among all BAP PDUs newly received from a child node and/or all UL BAP PDUs buffered or awaiting transmission with a new routing ID. Further, the migrating IAB node allocates a new BH RLC channel associated with the old BAP routing ID.

Thereafter, by applying configuration information included in a BAP mapping & routing configuration msg through an F1AP, the migrating IAB node performs routing of PDUs in which the BAP header is rewritten, and transmits the UL BAP PDU to the pre-allocated BH RLC channel through the target path.

As an alternative, the BAP header change config is transferred to the HO CMD, and contents of the BAP mapping configuration msg, which was transferred to the existing F1AP, may be included in the RRCReconfiguration message after HO CMD or HO complete, and the moment the message is received, IAB routing, BH RLC CH configuration information, and IP to routing ID configuration information are applied.

In this case, in a HO preparation step, a routing configuration considering the addition of a migrating node should be transferred and applied to all IAB nodes related to the migrating IAB node on the topology under the target CU. (Previously performed after migrating RRC complete)

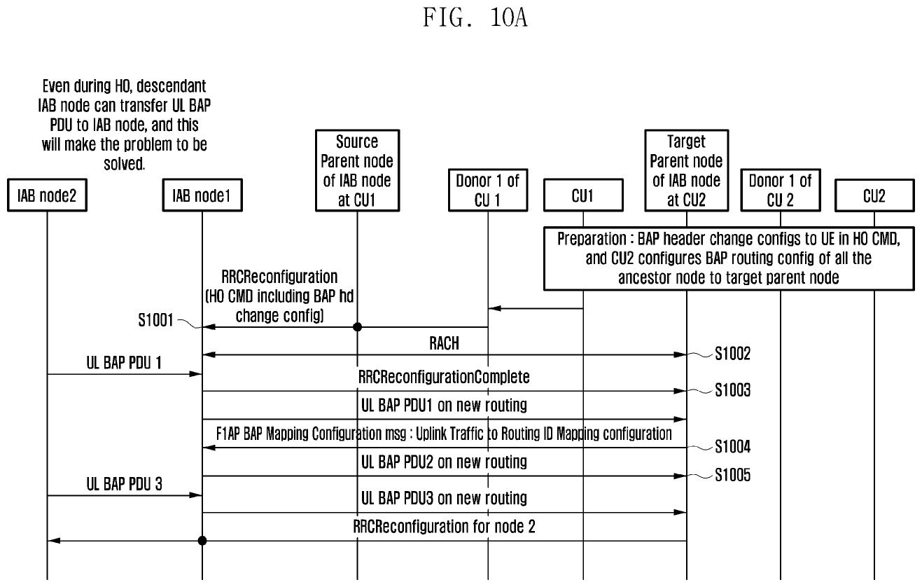

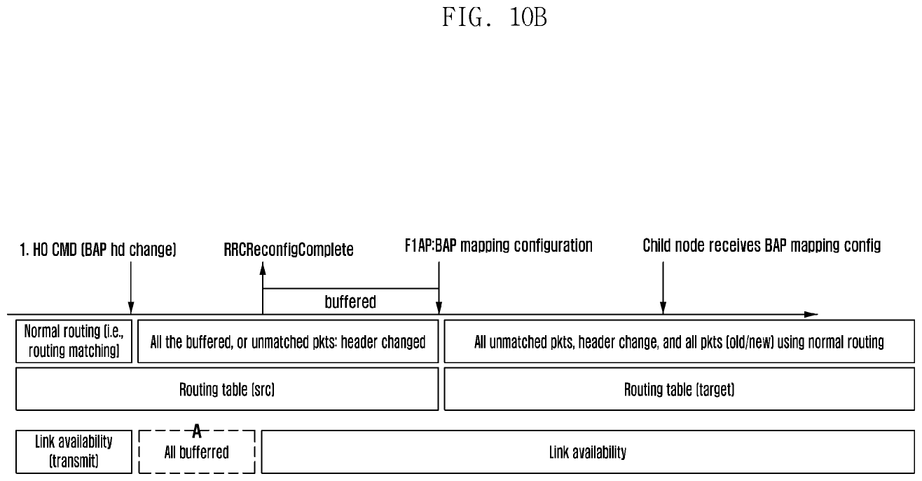

FIG. 10A illustrates the case that the above-described BAP header change configuration information is included in a HO command and transmitted and that a BAP mapping config is provided as a F1AP signal.

In this case, the migrating IAB node (IAB node 1) may receive BAP header change configuration information transmitted by the target CU through the HO CMD (S1001). From a time at which this information is received, the migrating IAB node applies BAP header change configuration information to all UL BAP PDUs transferred thereto to perform header rewriting.

The migrating IAB node that has received the HO CMD and BAP header change configuration information performs random access (S1002) and if random access is successful, the migrating IAB node transmits an RRCReconfigurationComplete message to the target IAB node (target parent node of IAB node at CU2) (S1003). When a BAP mapping configuration is received through the F1AP (S1004), packets having an old routing ID are header rewritten and then routing is performed based on mapping information of the BAP mapping configuration (S1005).

FIG. 10B illustrates operations performed by a migrating IAB node in chronological order in this case.

1. The UE (migrating IAB node) receives an HO CMD,
compares headers of all BAP PDUs received from now on (and/or awaiting transmission) and/or
headers of all buffered BAP PDUs by a BAP header change configuration, and
rewrites a routing ID of a header of the BAP PDU having an old routing ID into the corresponding new routing ID.

2. The link is unavailable until transmission of RRCReconfigComplete, and during that period, even if the above header has been rewritten, the header may still be buffered.

3. After complete transmission, the routing table should be followed, but because the routing table is configured from a source CU, a routing ID in which the BAP header is newly rewritten and the current routing entry may exist in an unmatched state and still be buffered.

4. After receiving an F1AP BAP mapping configuration, the routing configuration reflects the target path. At this time point, BAP PDUs having source-side routing IDs (old routing IDs) received by all migrating IAB nodes are header rewritten, and UL BAP SDUs generated in the migrating IAB node receive allocation of routing IDs according to mapping information of the BAP mapping configuration and then follow the given routing as it is.

A specific timer value is indicated together with the BAP header change configuration; thus, a time during which the corresponding BAP header change configuration is used may be limited. That is, the corresponding timer is started at a time point of receiving the HO CMD, and in the case that the corresponding timer has expired, header change information is not applied any more.

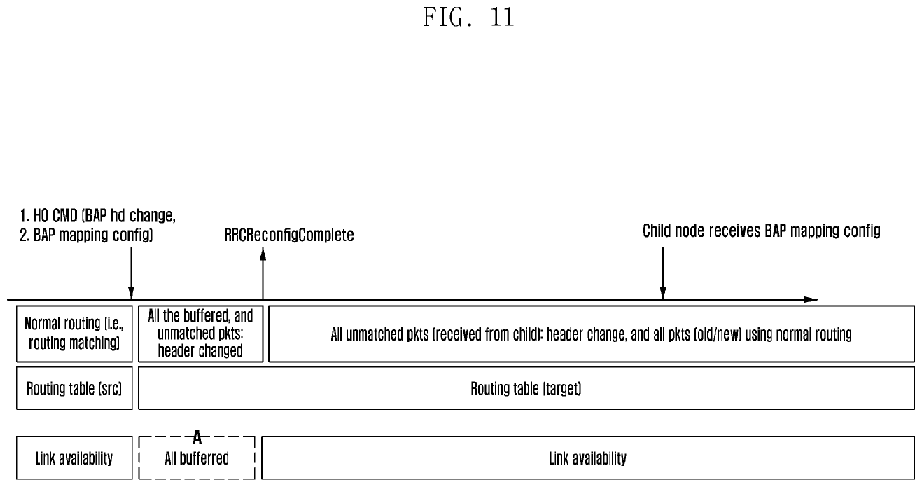

FIG. 11 illustrates an operation of a migrating IAB node in time in the case that a header change configuration and a BAP mapping configuration are transmitted together to a HO command.

1. The UE may receive an HO CMD,
compare headers of all BAP PDUs received from now on (and/or awaiting transmission) and/or headers of all buffered BAP PDUs by a BAP header change configuration,
and rewrite a routing ID of the header of the BAP PDU having an old routing ID into the corresponding new routing ID. Further, the UE may apply a routing configuration based on topology of the target CU using a BAP mapping configuration and start routing.

2. The link is unavailable until transmission of RRCReconfigComplete, and during that period, the header change packets may still be buffered.

After HO complete, when the link is available, buffered packets are transmitted using target-based routing, and in this case, UL BAP PDUs that do not match a current routing entry received from a child node perform header rewriting by applying the above header change configuration, and an UL BAP SDU newly generated in the migrating IAB node receives allocation of a new routing id from a BAP mapping configuration & routing configuration of the F1AP, performs routing based on the current routing entry, and is transmitted to the target path.

In this case, timer information is transmitted together in the HO CMD; thus, it is possible to limit how long header change configuration information is used.

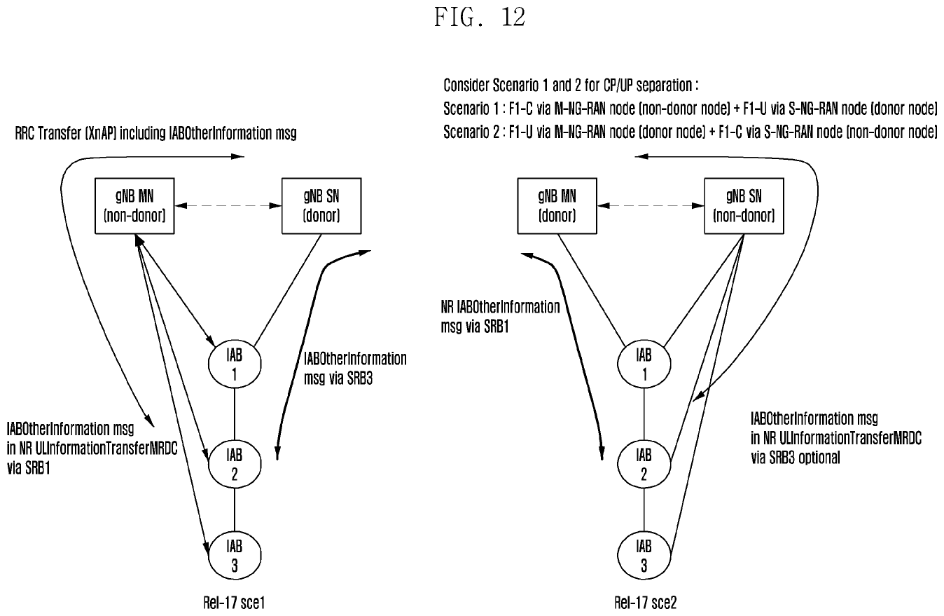

FIG. 12 is a diagram illustrating a scenario of processing an IP address in the case that a control plane and a user plane are separated in an IAB according to an embodiment of the disclosure.

In the case of dual connectivity (DC) in an IAB network, the following two scenarios are possible.

Scenario 1: F1-C via M-NG-RAN node (non-donor node)+F1-U via S-NG-RAN node (donor node)

Scenario 2: F1-U via M-NG-RAN node (donor node)+F1-C via S-NG-RAN node (non-donor node)

To request IP address allocation or to report a pre-allocated IP address to a donor, An IAB node (MT) is configured to NR-DC, in the case that the MN is a non-donor node and that an SN is a donor node,
if SRB3 is established,
transmit IABOtherInformation to SRB3
or not,
include an IABOtherInformation message in NR RRC
ULInformationTRansferMRDC and transfer the NR RRC
ULInformationTRansferMRDC to the MN through SRB1

The MN transfers the received IABOtherInformation message to the SN as RRC transfer message (procedure)

In contrast, in the case that the SN is a non-donor node and that the MN is a donor node,

Transfer IABOtherInformation to the MN as SRB1 or NR MCG

(In addition) in the case that SRB3 is established and that SRB1 is in suspension or RLF situation,

include an IABOtherInformation message in a ULInformationTransfer (MRDC) message and transfer the ULInformationTransfer (MRDC) message to the SN;

The SN may include the IABOtherInformation message in an RRC transfer procedure and transmit the IABOtherInformation message to the MN.
For the above operation, it should be possible to distinguish whether the IAB node (MT) is a scenario 1 or a scenario 2.

It may be distinguished by a status (condition) of an RRCReconfiguration message including a BAP-config or IP other configuration

Scenario 1: in the case that the received RRCReconfiguration (RRCReconfiguration including BAP-config or IP other configuration in a shallowest field structure) message is received to SRB3, or the RRCReconfiguration message is included in NR-SCG of mrdc-SecondaryCellGroup and received to SRB1, the UE may recognize that it is the scenario 1. In NR DC, it means that a RRCReconfiguration is created in the SN (should be checked before a scenario 2)

Scenario 2: when it is not the above case and the received RRCReconfiguration message (RRCReconfiguration including BAP-config or IP other configuration in the shallowest field structure) is received through SRB1, it is recognized as the scenario 2.

In specific embodiments of the disclosure described above, components included in the disclosure were expressed in the singular or plural according to presented specific embodiments. However, the singular or plural expression is appropriately selected for a situation presented for convenience of description, and the disclosure is not limited to the singular or plural components, and even if a component is represented in the plural, it may be formed with the singular, or even if a component is represented in the singular, it may be formed with the plural.

In the detailed description of the disclosure, although specific embodiments have been described, various modifications are possible without departing from the scope of the disclosure. Therefore, the scope of the disclosure should not be limited to the described embodiments and should be defined by the claims described below as well as by those equivalent to the claims.

1-14. (canceled)

15. A method performed by an integrated access and backhaul (IAB) node in a communication system, the method comprising:
obtaining, from a central unit (CU) of a target IAB donor, first information on a backhaul adaptation protocol (BAP) header rewriting, wherein the first information including information on a mapping between an old routing identifier (ID) associated with a first topology of a source IAB donor and a new routing ID associated with a second topology of the target IAB donor;
in case that a BAP packet to be considered for the BAP header rewriting is identified, rewriting a first routing ID of the first topology included in a header of the BAP packet to a second routing ID of the second topology corresponding to the first routing ID based on the first information; and
routing the BAP packet with the rewritten header, through a target path identified based on the second routing ID.

16. The method of claim 15 further comprising:
obtaining, from the CU of the target IAB donor, second information on a backhaul (BH) routing between the target IAB donor and the IAB node.

17. The method of claim 16,
wherein the second information includes information on a next hop BAP address mapped with the second routing ID, and
wherein the second routing ID includes a BAP's address and a path identity (ID) for the target path.

18. The method of claim 17, wherein the routing the BAP packet with rewritten header further comprises:
identifying that a destination of the BAP packet is a distributed unit (DU) of the target IAB donor based on the BAP's address;
identifying a target parent IAB node corresponding to the next hop address; and
transmitting, to the target parent IAB node, the BAP packet through a BH radio link control (RLC) channel allocated on the target path.

19. The method of claim 16,
wherein the first information is obtained with the second information at a distributed unit (DU) of the IAB node, through a CU of the source IAB donor based on an F1 application protocol (F1AP).

20. The method of claim 15, further comprising:
receiving, at a mobile terminal (MT) of the IAB node from the source IAB donor, a radio resource control (RRC) message including a handover command and uplink default configuration for the target path,
wherein the uplink default configuration including a default backhaul (BH) routing ID and a default BH radio link control (RLC) channel.

21. The method of claim 20,
wherein the first information is obtained from the RRC message.

22. An integrated access and backhaul (IAB) node in a communication system, the IAB node comprising:
a transceiver; and
a controller configured to:
obtain, from a central unit (CU) of a target IAB donor, first information on a backhaul adaptation protocol (BAP) header rewriting, wherein the first information including information on a mapping between an old routing identifier (ID) associated with a first topology of a source IAB donor and a new routing ID associated with a second topology of the target IAB donor,
in case that a BAP packet to be considered for the BAP header rewriting is identified, rewrite a first routing ID of the first topology included in a header of the BAP packet to a second routing ID of the second topology corresponding to the first routing ID based on the first information, and
route the BAP packet with the rewritten header, through a target path identified based on the second routing ID.

23. The IAB node of claim 22,
wherein the controller is further configured to obtain, from the CU of the target IAB donor, second information on a backhaul (BH) routing between the target IAB donor and the IAB node.

24. The IAB node of claim 23,
wherein the second information includes information on a next hop BAP address mapped with the second routing ID, and
wherein the second routing ID includes a BAP's address and a path identity (ID) for the target path.

25. The IAB node of claim 24, wherein the controller is further configured to:
identify that a destination of the BAP packet is a distributed unit (DU) of the target IAB donor based on the BAP's address;
identify a target parent IAB node corresponding to the next hop address, and
control the transceiver to transmit, to the target parent IAB node, the BAP packet through a BH radio link control (RLC) channel allocated on the target path.

26. The IAB node of claim 23,
wherein the first information is obtained with the second information at a distributed unit (DU) of the IAB node, through a CU of the source IAB donor based on an F1 application protocol (F1AP).

27. The IAB node of claim 22,
wherein the controller is further configured to control the transceiver to receive, at a mobile terminal (MT) of the IAB node from the source IAB donor, a radio resource control (RRC) message including a handover command and uplink default configuration for the target path, and
wherein the uplink default configuration including a default backhaul (BH) routing ID and a default BH radio link control (RLC) channel.

28. The IAB node of claim 27,
wherein the first information is obtained from the RRC message.
